(19) United States
(12) Patent Application Publication
(10) Pub. No.: US 2025/0089941 A1
(43) Pub. Date: Mar. 20, 2025

(54) INDUCTION GRIDDLES

(71) Applicant: W.C. BRADLEY CO., Columbus, GA (US)

(72) Inventors: RAMIN KHOSRAVI RAHMANI, Columbus, GA (US); JAMES D. KRING, Opelika, AL (US); Thomas Kessler, Columbus, GA (US)

(21) Appl. No.: 18/538,660

(22) Filed: Dec. 13, 2023

Related U.S. Application Data
(60) Provisional application No. 63/432,244, filed on Dec. 13, 2022.

(51) Int. Cl. A47J 37/06; H05B 6/12

(52) U.S. Cl. CPC A47J 37/0676; H05B 6/1254

(57) ABSTRACT

The invention relates to a cooking system utilizing a single-zone or multi-zone induction-based griddle that provides uniform heat across a cooking surface. The system provides a larger cooking surface, a shorter warmup time, and a more targeted heating with a more uniform temperature distribution. A multi-layer cooking surface may converting a magnetic field into a thermal field by employing ferritic stainless steels, e.g., in an upper and lower layer. A middle layer(s) enhances heat transfer towards the entire cooking surface and stores a proper amount of heat inertia in the system. The middle layer, e.g., of aluminum, copper, or carbon-based materials may be separated into zones separated by cavities filled with insulation materials. The system may be utilized for indoor or outdoor grills.

### CROSS-REFERENCE TO RELATED CASES

This application claims the benefit of U.S. provisional patent application Ser. No. 63/432,244, filed on Dec. 13, 2022, and incorporates such provisional application by reference into this disclosure as if fully set out at this point.

### FIELD OF THE INVENTION

This disclosure relates to cooking via induction heating in general and, more specifically to induction griddles.

### BACKGROUND OF THE INVENTION

Electric powered griddles are currently available, and are mostly directed to indoor usage. Resistive heating elements such as Calrod® heating elements are sometimes employed. As a voltage is applied to the resistive heating element, electrical energy is converted to thermal energy. This thermal energy is transferred, primarily via radiation, to a cooking surface or griddle.

Griddles that generate heat from combustion of a hydrocarbon fuel (such as liquid propane or natural gas) benefit from multiple heat transfer mechanisms, including radiative and convective transfers. Also, the high level of energy intensity stored in hydrocarbon fuels makes it possible for reasonable heating and cooking performance of a griddle, even if the system has a relatively low thermal efficiency.

Electric griddles lack substantial energy transfer into the cooking chamber via convective mass transfer (e.g., via combustion products). Current electric power grids also impose limitations on available power. These factors result in a longer initial warmup time for the griddle, a longer recovery time, and lower temperature and heat available for cooking. These limitations of electric griddles are more pronounced where resistive heating elements are used. The radiative nature of such heating elements leads to a large portion of the generated heat being emitted away from the cooking surface (e.g., as shown in FIG. 1) producing an inefficient heat transfer mechanism with a thermal efficiency of about 20 to 30%.

Induction coils can also be used to generate heat for cooking. An alternating current flowing in the induction coil generates a localized magnetic field. In the presence of a cooking vessel (e.g., a pot or a pan) made with ferric metals, the cycling magnetic field induces eddy currents in the metal that generate ohmic heat in the metal.

Induction cooktops benefit from a higher thermal efficiency (of about 70 to 80%) by means of heating only the cooking surface. This makes induction cooking more suitable for indoor usage, with a cooking vessel being the target of localized heating. However, this concentration of energy into a small, circular plane makes the current induction-based cooktop less suitable for griddles, as areas of concentrated heat result in a cooking surface with spots that are either too hot or too cold for proper cooking (e.g., as shown in FIG. 2).

What is needed is a system and method for addressing the above, and related issues.

### SUMMARY OF THE INVENTION

The invention relates to a single-zone or multi-zone induction-based griddle that can provide uniform heat across a cooking surface of a given zone. The invention allows employing higher efficiency induction technology to offer an electric griddle that can provide a larger cooking surface, a shorter warmup time, and single or multiplate cooking zones with a more targeted heating with a more uniform temperature distribution across each zone.

In one embodiment a multi-layer cooking surface is provided. Converting the magnetic field into a thermal field can be achieved by employing ferritic stainless steels.

The purpose of the middle layer(s) is to enhance the heat transfer towards the entire cooking surface and to store proper amount of heat inertia in the system.

In greater detail, the invention relates to a cooking system having a cooking plate with a top layer, a highly conductive middle layer, and a lower layer. An induction coil is located proximate to the lower layer, the induction coil for generating a magnetic field for heating the lower layer.

In one embodiment, the top layer has a single heating area. In a second embodiment, the top layer has a multi-zone heating area. The multi-zone heating area may include at least two cooking surfaces separated by cavities. The cavities may be filled with insulating materials.

In one embodiment, the top layer is comprised of stainless steel and the middle layer is comprised of aluminum or copper, and the lower layer is comprised of stainless steel. The middle layer may include at least two layers wherein each layer is comprised of a different metal or alloy.

The top layer preferably has a lower thermal conductivity than the middle layer.

In one embodiment, the middle layer is comprised of carbon-based materials, one of the top layer and the lower layer is comprised of glass and the other of the top layer and the lower layer is comprised of metal.

In one embodiment, at least two of the top layer, the middle layer, and the lower layer are held together by chemical bonding or cladding. In one embodiment, at least two layers of the top layer, the middle layer, and the lower layer are held together by nesting the at least two layers. In one embodiment, the top layer and the lower layer are non-ferritic and the lower layer is nested in a ferritic base.

In one embodiment, the cooking system is an outdoor grill or a component of an outdoor grill. In another embodiment, wherein cooking system is an indoor grill or a component of an indoor grill.

### BRIEF DESCRIPTION OF THE DRAWINGS

FIG. 1 is a simplified cutaway view of a grill based on radiative heating elements and illustrating wasted heat energy;

FIG. 2 is a simplified cutaway view of a traditional induction-based grill having overheated and underheated areas;

FIG. 3A is a heat distribution map showing temperature across an induction coil heated griddle surface that is 1.6 mm thick 430SST;

FIG. 3B is a heat distribution map showing temperature access, an induction coil heated multi-layered griddle surface that is 1.6 mm thick 430SST and 2.3 mm aluminum;

FIG. 4A is an example showing plan view, end view, and frontal view of a dual-zone multi-layer cooking surface having a 22 gauge 304SST top layer, a 6 gauge 7072 AL×2 middle layer and a 16 gauge 409SST base layer;

FIG. 4B is an example showing plan view, end view, and frontal view of a dual-zone multi-layer cooking surface having a 22 gauge 304SST top layer, a 6 gauge 7072 AL×2 middle layer and an 8 gauge 409SST base layer;

FIG. 4C is an example showing plan view, end view, and frontal view of a dual-zone multi-layer cooking surface having a 22 gauge 304 SST top layer, a 6 gauge 7072 AL×2 middle layer and an 8 gauge 430SST base layer;

FIG. 5A is an example of an overhead plan view (absent an upper layer) of multi-layer cooking plates according to the present disclosure;

FIG. 5B is an example of an overhead plan view (absent an upper layer) of multi-layer cooking plates according to the present disclosure;

FIG. 5C is an example of an overhead plan view (absent an upper layer) of multi-layer cooking plates according to the present disclosure;

FIG. 5D is an example of an overhead plan view (absent an upper layer) of multi-layer cooking plates according to the present disclosure;

FIG. 6A is an example, via cutaway view, of an example construction of a multi-layer cooking surface according to the present disclosure;

FIG. 6B is an example, via cutaway view, of an example construction of a multi-layer cooking surface according to the present disclosure;

FIG. 6C is an example, via cutaway view, of an example construction of a multi-layer cooking surface according to the present disclosure;

FIG. 6D is an example, via cutaway view, of an example construction of a multi-layer cooking surface according to the present disclosure;

FIG. 6E is an example, via cutaway view, of an example construction of a multi-layer cooking surface according to the present disclosure;

FIG. 6F is an example, via cutaway view, of an example construction of a multi-layer cooking surface according to the present disclosure;

FIG. 6G is an example, via cutaway view, of an example construction of a multi-layer cooking surface according to the present disclosure;

FIG. 6H is an example, via cutaway view, of an example construction of a multi-layer cooking surface according to the present disclosure;

FIG. 7A is an overhead view and a side view of a dual zone multi-layer griddle according to the present disclosure;

FIG. 7B is a heat level map according to the present disclosure;

FIG. 8 is a perspective view of non-ferric highly conductive cooking plates being nested in a ferric base;

FIG. 9 is a temperature distribution in map for a dual-zone multi-layer griddle (with SST304 as the top layer) according to the present disclosure;

FIG. 10 is a temperature distribution in map for a dual-zone multi-layer griddle (with SST430 as the top layer) according to the present disclosure;

FIG. 11A shows an example construction of an induction coil;

FIG. 11B shows an example construction of multiple induction coils;

FIG. 11C shows an example construction of an induction coil;

FIG. 11D shows an example construction of multiple induction coils.

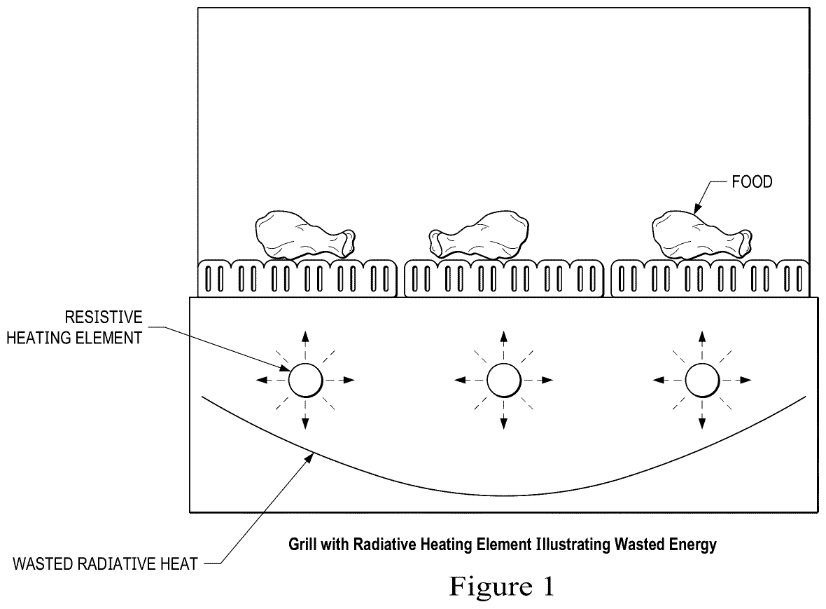

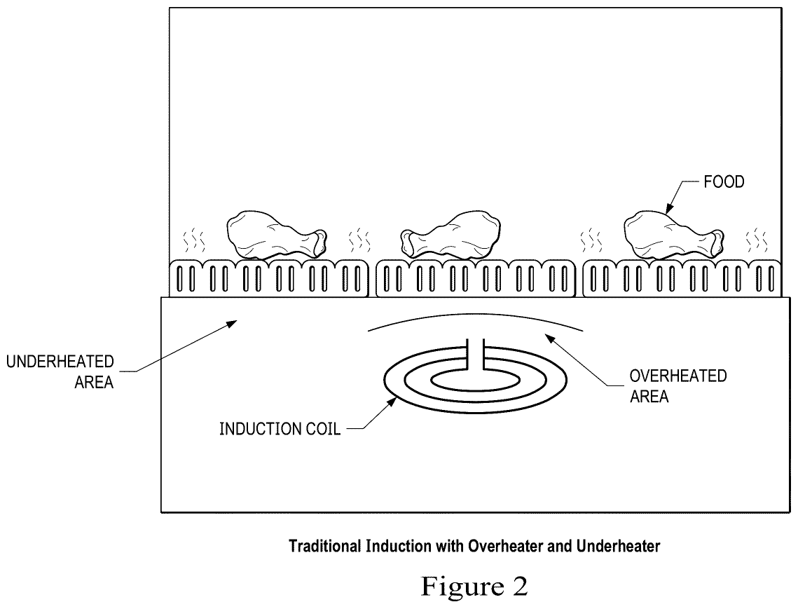

### DETAILED DESCRIPTION OF THE PREFERRED EMBODIMENTS

Embodiments of the present disclosure comprise a single-zone or multi-zone induction-based griddle that can provide uniform heat across the cooking surface of a given zone. The griddle may be utilized in an outdoor grill as is known in the art, or on any other context for which a cooking griddle is desired. Embodiments of the present disclosure utilize the higher efficiencies of induction technology (compared to resistive technology) to offer an electric griddle that can provide a larger cooking surface, a shorter warmup time, and more targeted heating with a more uniform temperature distribution (across each zone).

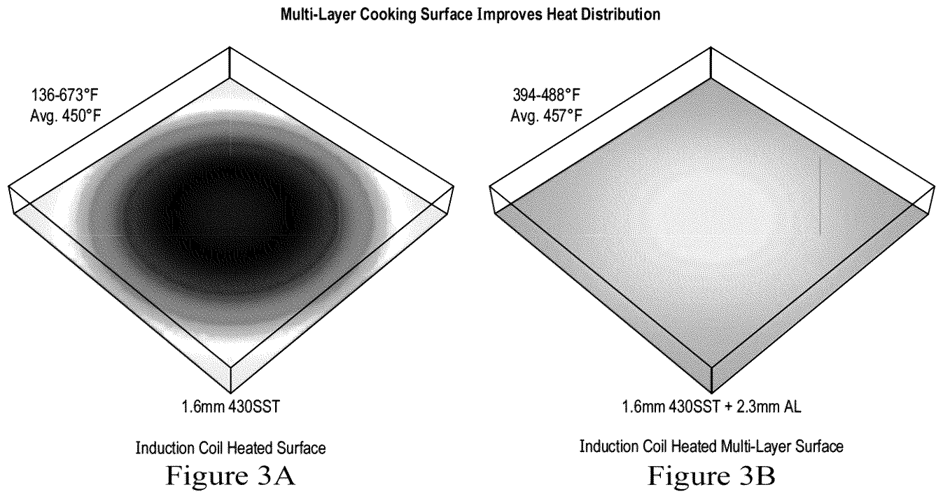

FIGS. 3A and 3B show two separate temperature distributions on a relatively small cooking surface of 175 by 175 mm, heated by an induction coil (with 58 mm ID and 152 mm OD). A target temperature is set to be about 450° F. FIG. 3A shows a temperature distribution where only stainless steel is used as the cooking surface. FIG. 3B shows the case for a two-layer part made of steel and aluminum, according to various embodiments of the present disclosure.

As can be seen in FIG. 3A, in the absence of the aluminum plate, a hot zone is focused above the magnetic field, generated by the induction coil. The areas of the steel plate that are not directly above the magnetic field remain cold. Although the average temperature is about 450° F., there is about 535 to 540° F. difference between the hot spot and the cold spot(s). This temperature difference is far in excess of any acceptable value for an acceptable cooking experience (even across a relatively small area).

FIG. 3B shows the impact on the heat distribution of the multi-layered cooking surface construction including an aluminum layer. Although the average temperature is almost the same as in the non-layered version of FIG. 3A, the difference between the hot and cold spots is reduced to less than 100° F. The inclusion of the aluminum layer is believed to be largely responsible for this effect, as the thermal conductivity of stainless steel is only about one-tenth that of aluminum.

In practice, it is preferred to avoid direct contact between food and aluminum. Also, aluminum may not be sufficiently hard, and therefore not sufficiently durable against the impact of hard cooking utensils. Therefore, according to some embodiments, three or more layers of different metals (or alloys) are utilized to achieve a high rate of conversion of the magnetic field to thermal field, high rate of heat transfer to the cooking surface, low temperature gradient across the cooking surface, and high resistance to impact, scratch, and corrosion at the cooking surface. The importance of corrosion resistance is even more important for outdoor cooking applications.

Converting a magnetic field into thermal energy can be achieved by placement of ferritic stainless steels into the magnetic field. Among this category SST409 offers a very high level of iron content (about 85 to 90%). SST430, SST443, and SST444 are useful alloys in this regard. Although iron accounts for about 75 to 85% of the composition for the 430 and 443 grades, they offer better corrosion resistance, specifically in higher temperature conditions.

As regarding thickness of the ferritic stainless steel layer, its structural integrity needs to be considered in addition to penetration of the magnetic field. On the one hand, it is desired to minimize the thermal inertia in the ferritic plate. On the other hand, as the temperature at the area of concentrated magnetic field increases sharply, the thermal stress can cause metal deformation or warpage. In various embodiments, the inventors have found a material thickness of about 1.6 to 2.8 mm (16- to 12-gauge) to provide a good balance.

A purpose of the middle layer(s) is to enhance the heat transfer towards the entire cooking surface and to store a proper amount of heat inertia in the system. Non-ferromagnetic materials with high thermal conductivity such as aluminum and copper can be considered for the middle layer(s). There are other materials such as silver and gold which have high thermal conductivity, but these might not be practical choices for industry.

Pure copper has a thermal conductivity of about 380 to 400 W/m·K and its specific heat is about 390 J/Kg·K. Pure aluminum has a thermal conductivity of about 230 to 240 W/m·K and its specific heat capacity is about 910 J/Kg·K. Aluminum has a density of about 2700 Kg·m³, while copper density is about 8900 Kg·m³. In other words, thermal conductivity of copper is about 70% higher than the thermal conductivity of aluminum, while the heat capacity inertia of copper is about 40% higher than the heat capacity inertia for aluminum.

For the middle layer(s), an aluminum plate with a thickness of about 2.6 to 5.2 mm (10- to 4-gauge) can provide a balance between thermal inertia and heat transfer (and temperature distribution) on the one hand, and the time needed to reach desired cooking temperature on the other. In some embodiments, there are multiple middle layers. These may comprise different alloys of aluminum, or combinations of aluminum and copper, to optimize the material and manufacturing as well as thermal performance.

The high thermal conductivity of aluminum and copper allows for a better cooking experience when starting with a lower starting temperature (compared to a griddle surface made only of steel). As cold food comes in contact with the griddle surface, the large temperature gradient between the food and the griddle surface increases the rate of heat transfer from the griddle to the food at the contact point. This local drop of the thermal inertia can be better compensated by the energy stored in the neighboring material when it has higher thermal conductivity. Also, layer(s) of carbon-based materials (such as graphene or graphite) can be sandwiched between the bottom and top layers. Carbon based materials such as graphite flakes have thermal conductivity of 800 to 2,000 W/m·K with a density of 2200 to 2,300 Kg/m3. These properties allow for superior heat transfer (distribution) in by the middle layer and resolve the issue of heat generation intensity that is a characteristic of induction-based heating.

For the surface exposed to food, i.e., a top layer, resistance to corrosion and scratch is important. Also, in the case of zonal cooking, it is preferred that this surface has a lower thermal conductivity. A thin sheet of material with proper thermal conductivity can minimize the shell conduction (and therefore, allow for zonal heating and cooking), while still effectively transferring heat in direction normal to its surface (e.g., outward toward the food). Austenitic stainless steels provide a good option by having superior corrosion resistance and notably lower thermal conductivity compared to regular steel. For example, SST304, SST309, and SST316 have thermal conductivity values about less one-third of the one for regular steel, while resisting corrosion effectively, even in the present of high ambient temperatures and salty conditions (typical for cooking). This layer may be relatively thin e.g., about 0.6 to 1.0 mm (24- to 20-gauge).

The following formula can be used to optimize the effective thermal conductivity (K) of the plate made of n layers for the accumulative thickness (L):

$$\frac{L}{K} = ( \frac{{L}_{1}}{{K}_{1}} + \frac{{L}_{2}}{{K}_{2}} + ⋯ + \frac{{L}_{n}}{{K}_{n}} )$$

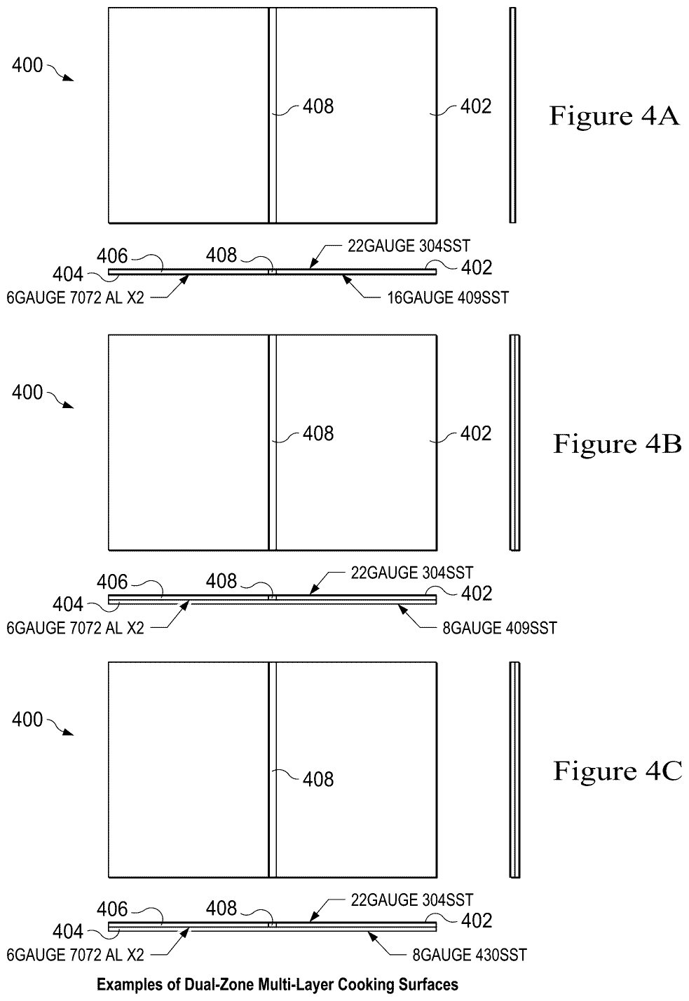

FIGS. 4A, 4B and 4C illustrate examples of three-layer cooking plates 400 made of four sheets. The top plate 402 is 300 series stainless steel and the bottom plate 404 is made of 400 series stainless steel. Two slabs of aluminum 406 are bonded between stainless steel top plate 402 and stainless steel with plate 404. There is a cavity 408 between the aluminum slabs to divide the cooking surface into two zones. In the example cooking plate 400 of FIG. 4A, a 22-gauge 304SST is provided as top plate 402, 16-gauge 409SST is provided as bottom plate 404 and 6-gauge 7072AL is provided as layers 406. The example cooking plate 400 of FIG. 4B differs in that bottom plate layer 404 is 8-gauge 409SST. The example cooking plate of FIG. 4C utilizes 8-gauge 430SST for bottom plate layer 404.

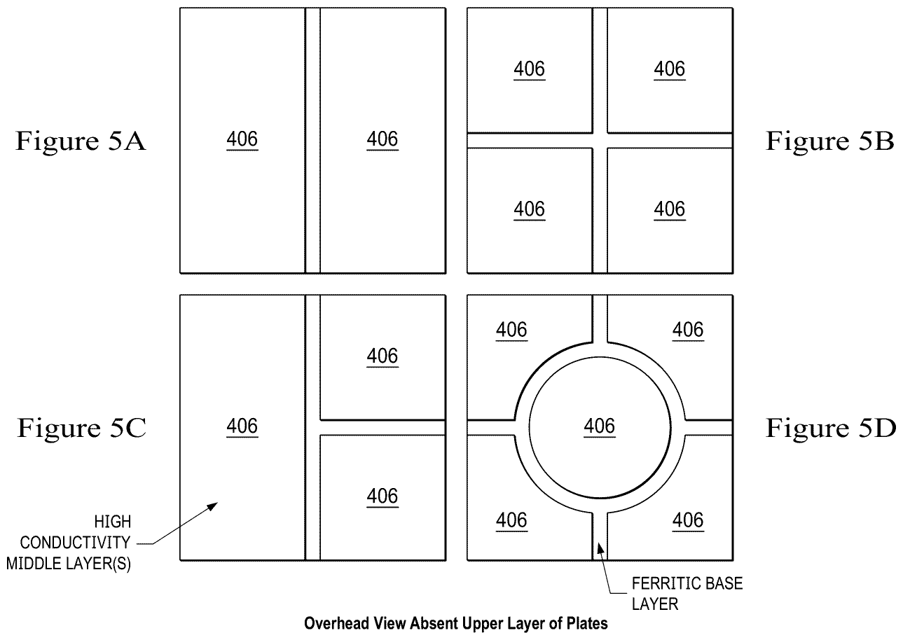

As shown in FIGS. 5A-5D, mid layer(s) 406 (whether aluminum, copper, or other material) may divide the cooking surface into two halves as shown in FIG. 5A, four quadrants as shown in FIG. 5B, a half section and two quarters as shown in FIG. 5C, or a central portion with separate peripheral portions as shown in FIG. 5D. One of skill in the art can easily envision various designs having different numbers of aluminum or copper slabs or films of carbon structure (e.g., graphite or graphene) bonded between sheets of stainless steel (separated by proper cavities) to create different zonal arrangements within the spirit of the present disclosure. Alternatively, different metals and alloys with different numbers of layers may achieve similar effects.

In further embodiments, a multi-zone cooking system may be constructed by combining single- or dual-zone multi-layer plates into one assembly. Each multi-layer module can be flat or have a different geometry (such as forming around its perimeters).

While chemical bonding or cladding may be used to attach layers of materials in constructing griddles according to the present disclosure, they may also be nested or otherwise physically held together. Alternatively, other methods of manufacturing can be used for having multiple layers. These methods can be, but not limited to, molding-over, or casting. For example, the high-conductive and corrosion-resistance segments can be surrounded by ferritic material through molding. A combination of different processes (such as forming and cladding) can be used to manufacture the plates.

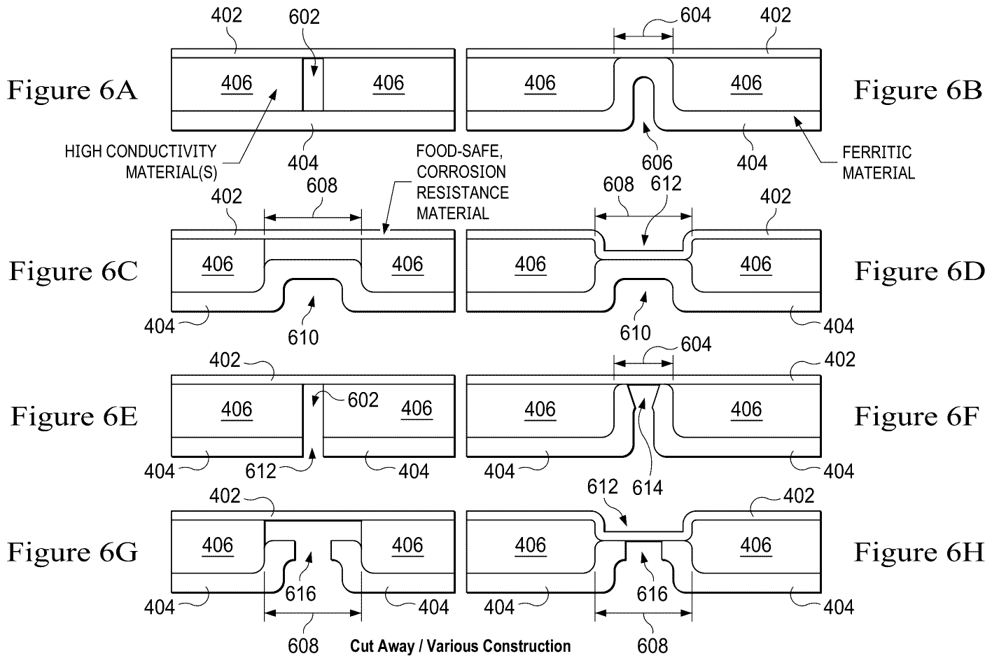

FIGS. 6A-6G illustrate a variety of ways in which the boundary between cooking zones may be established according to the present disclosure. The example cooking plates of FIGS. 6A-6H each utilize a top layer or top plate 402 and a base or ferritic layer 404. Interposing these layers is one or more middle layers 406. As described above, the top layer 402 may be wear and corrosion resistant in cooking conditions. The base layer 404 is ferritic and becomes heated when exposed to an appropriate magnetic field. The middle layer(s) 406 serve to transfer heat between the bottom layer 404 and the top cooking layer 402.

Demarcations between cooking zones may be implemented by a break or interruption in the mid layer 406. As shown in the cooking plate of FIG. 6A, a gap 602 may be defined that slows heat transfer in the middle layer 406 and thus isolates the cooking zone(s). As shown in the example cooking plate of FIG. 6B a gap 604 may be wide enough that the base layer or ferritic layer 404 is indented into the gap 604 and comes near or in contact with the upper layer 402. This indention 604 may be for structural or other reasons.

Gaps between adjacent portions of the middle layer(s) 604 can vary in width. An even wider gap 608 is shown in the example plate of FIG. 6C. In the example plate of FIG. 6C, the ferritic layer 404 has an indention 610 that is wider to fill the gap 608 but it does not reach the upper layer 402. In the example cooking plate of FIG. 6D, the upper layer 402 has an indention 612, possibly meeting the base layer or ferritic layer 404. This arrangement may be structural and/or informational as it allows the demarcation between cooking zone to be seen from above the cooking surface 402.

The example cooking plate of FIG. 6E provides a gap 602 interrupting the middle layer(s) 406 as well as a gap 612 interrupting the base layer or ferritic layer 404 below. In such a configuration, less heat is generated at the gap 602 where it is not needed (being immediately below a zone boundary). As shown in the example cooking plate of FIG. 6F, a wider gap 604 may be used allowing adjacent portions of the base layer or ferritic layer 404 to be pressed into the gap 604, while a gap in the ferritic layer 614 is preserved. Such configuration may be a structural arrangement or implement for heat flow purposes.

The configuration of example cooking plate of FIG. 6G uses a wide gap 608 in the mid layer(s) 406, as well as a gap 616 in the base layer or ferritic layer 404. Portions of the ferritic layer 616 are pressed into the gap 616 but they do not extend to the top layer 402. As shown in the example cooking plate of FIG. 6H, the top layer 402 may have an indention 612 to meet the ferritic layer 404 in the gap 608. This configuration may be structural, for heat flow purposes, and/or to indicate the cooking zone boundaries.

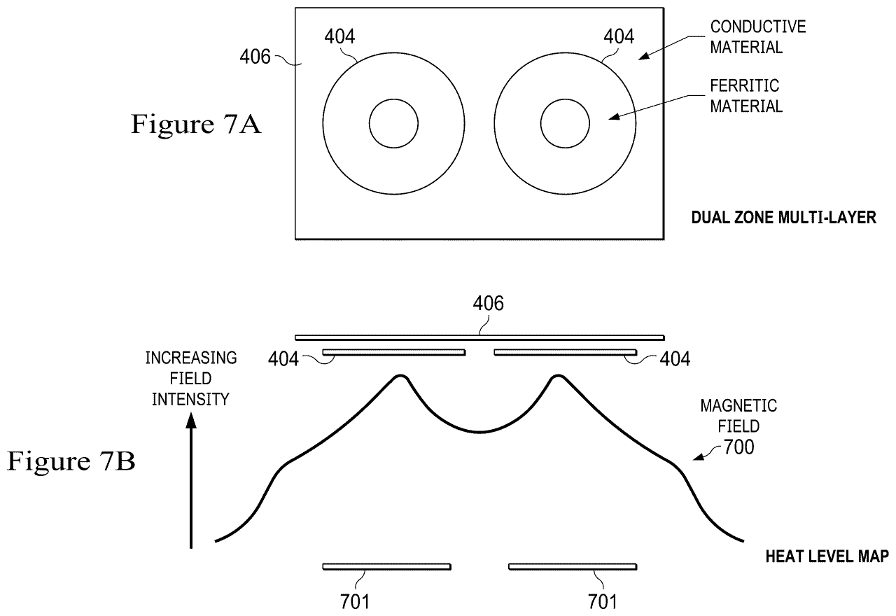

As shown in FIGS. 7A and 7B, in some embodiments, temperature distribution to the conductive or middle layer(s) 406 may be improved or fine-tuned by designing the base layer or ferritic layer 404 with a specific shape or outline. In this way heat is not generated across the entirety of the conductive layer(s) 406, and areas of high heat production (e.g., where the magnetic field is excessively strong) can be reduced or eliminated. Areas where the magnetic field is weak can also be devoid of ferritic materials and the conductivity of the mid layer(s) 406 relied upon to spread heat.

As shown in FIGS. 7A and 7B (which are not to scale), as the magnetic field 700 generated by the coils 701 is heavily concentrated above the coils 701, the non-continuous ferritic plate or plates 404 can only convert a portion of the magnetic field into thermal energy. Since the ferritic plate or plates 404 have a center an opening, there is no thermal energy source at the circular opening and the heat concentration is smoothed. Therefore, the generated heat that is then transferred into the next layer (e.g., layer 402) has a more uniform distribution. It should also be understood that the circular or toroidal form of the plate(s) 404 is exemplary, and other shapes can be arranged to take advantage of different magnetic fields and desired heat production attributes.

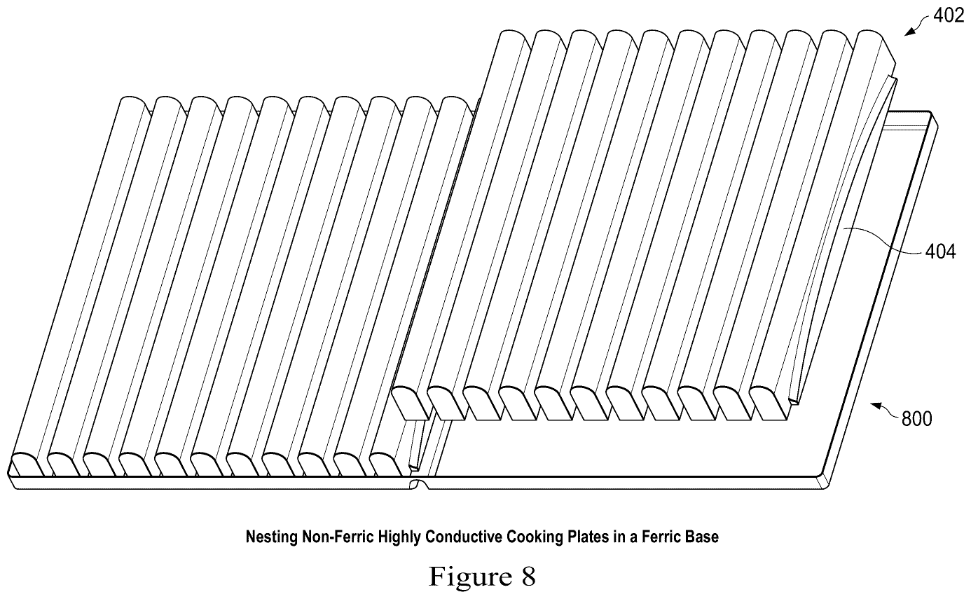

In another embodiment, both top layer 402 and bottom layer 404 are made of the same material (such as 400 series stainless steel). With material for both top layer 402 and base layer 404 being non-ferritic, the cooking plate can be nested in a ferritic nest 800. The cooking plates 402, 404 can be permanently positioned or removeable (FIG. 8).

Cavities, e.g., cavity 408 of FIGS. 4A-4C, between the middle layers of a multi-zone cooking surface may be filled with insulating materials, or any filler with very low thermal conductivity. Spaces between the middle layers can also be used to reinforce the structure of the cooking surface (for example, by having structural frames around the slabs of high conductive material).

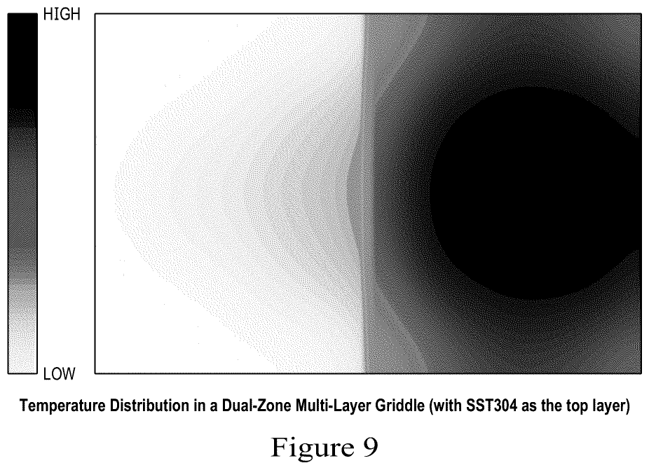

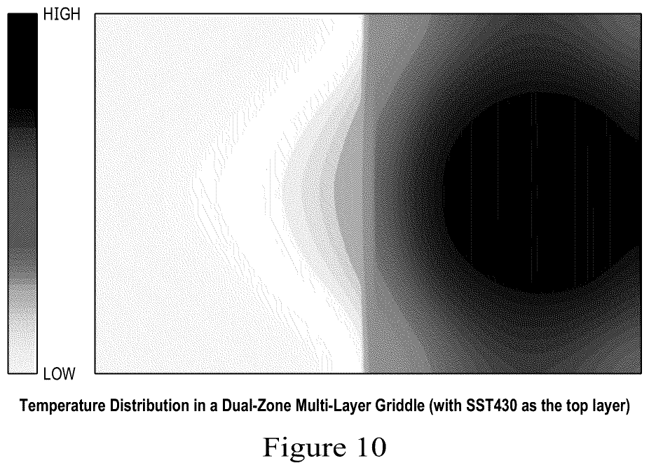

FIG. 9 illustrates the temperature distribution on the cooking surface of a dual-zone multi-layer griddle according to the present disclosure. The cooking surface is 270 by 410 mm and is constructed of two 2.1 mm aluminum slabs bonded between a top layer of a stainless steel plate having a thickness of about 0.8 mm and a bottom layer of a stainless steel late having a thickness of about 1.6 mm). The target temperature for the left side is 600° F. and the target temperature for the right side is 400° F. It can be seen that the temperature distribution across each zone is fairly uniform, while the two zones have distinguishably different temperatures. FIG. 10 illustrates a similar case where the stainless steel layer has nearly 50% higher thermal conductivity (430 vs. 304 grade). Mild heat spillage from the hotter right side to the left side can be observed. For the case of carbon films, one layer can be metal (e.g., 400 series stainless steel), and the other layer can be glass. However, using the same alloys as the top and bottom layer could reduce the potential for delamination of the cooking plate when exposed to different heating scenarios.

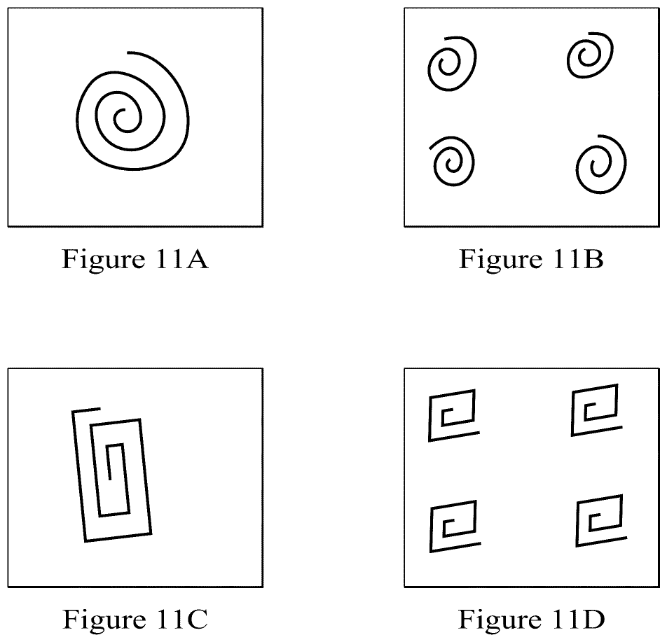

In further embodiments, the magnetic field can be manipulated to provide further fine tuning of different temperature zones or cooking zones. In some embodiments, multiple smaller round coils (see, e.g., FIGS. 11B, 11D) are clustered under each cooking zone. In other embodiments, different geometries for the magnetic coils may be employed (e.g., more oblong or rectangular (see, e.g., FIGS. 11C, 11D), rather than round (see, e.g., FIGS. 11A, 11B)). In each of these cases, it is possible to have variable distancing between adjacent rounds of wire to generate a less concentrated magnetic field.

The invention relates to a device and method as substantially as disclosed herein.

1. The cooking griddle of the invention may comprise a top plate; a heat conductive mid layer below the top plate; and a lower ferritic layer below the heat conductive layer; wherein the lower ferritic layer is exposed to a magnetic field to generate heat energy transferred through the mid layer to the top plate.

2. The cooking griddle of paragraph number 1, immediately above, wherein the mid layer is divided into at least two cooking zones by a vertical gap in the mid layer.

3. The cooking griddle of any of paragraphs number 1, 2, above, further comprising an induction coil providing the magnetic field.

4. The cooking griddle of any of paragraphs number 1-3, above, wherein the top plate comprises a 300 series stainless steel.

5. The cooking griddle of any of paragraphs 1-4, above, wherein the mid layer comprises at least one of aluminum and copper.

6. The cooking griddle of any of paragraphs 1-5, above, wherein the ferritic layer comprises a 400 series stainless steel.

7. The cooking griddle of any of paragraphs 1-6, above, wherein the mid layer is divided into a plurality of cooking zones by a plurality of vertical gaps in the mid layer.

8. The cooking griddle of any of claims 1-7, above, wherein the ferritic layer is formed into one or more geometric shapes to reduce induced heating at predetermined locations in the magnetic field.

9. The cooking griddle of any of claims 1-8, above, wherein the induction coil comprises a plurality of coils placed below the ferritic layer to control magnetic field strength and heat production at predetermined locations in the ferritic layer.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)−(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A cooking griddle comprising:
a top layer;
a heat conductive middle layer below said top layer;
a lower layer below said middle layer, wherein said lower layer is ferritic;
wherein said lower layer is exposed to a magnetic field to generate heat energy transferred through said middle layer to said top layer.

2. The cooking griddle of claim 1, wherein said middle layer is divided into at least two cooking zones by a gap in said middle layer.

3. The cooking griddle of claim 1, further comprising an induction coil providing said magnetic field.

4. The cooking griddle of claim 3, wherein said induction coil comprises a plurality of coils placed below said lower layer to control strength of said magnetic field and heat production at predetermined locations in said lower layer.

5. The cooking griddle of claim 1, wherein said top layer comprises stainless steel.

6. The cooking griddle of claim 1, wherein said middle layer comprises at least one of aluminum and copper.

7. The cooking griddle of claim 1, wherein said lower layer comprises stainless steel.

8. The cooking griddle of claim 1, wherein said lower layer is formed into one or more geometric shapes to reduce induced heating at predetermined locations in said magnetic field.

9. A cooking system comprising:
a top layer;
a middle layer adjacent said top layer, wherein said middle layer is highly conductive;
a lower layer adjacent said middle layer;
an induction coil proximate to said lower layer, said induction coil for generating a magnetic field for heating said lower layer.

10. The cooking system according to claim 9 wherein said top layer comprises a single heating area.

11. The cooking system according to claim 9 wherein said top layer comprises a multi-zone heating area.

12. The cooking system according to claim 11 wherein:
said multi-zone heating area is comprised of at least two cooking surfaces separated by cavities.

13. The cooking system according to claim 12 wherein:
cavities are filled with insulating materials.

14. The cooking system according to claim 9 wherein:
said top layer is comprised of stainless steel; and
said middle layer is comprised of aluminum or copper.

15. The cooking system according to claim 9 wherein:
said middle layer is comprised of at least two layers.

16. The cooking system according to claim 15 wherein:
each of said at least two layers is comprised of a different metal or alloy.

17. The cooking system according to claim 9 wherein:
said lower layer is comprised of stainless steel.

18. The cooking system according to claim 9 wherein:
said top layer has a lower thermal conductivity than said middle layer.

19. The cooking system according to claim 9 wherein:
said middle layer is comprised of carbon-based materials.

20. The cooking system according to claim 19 wherein:
wherein one of said top layer and said lower layer is glass and the other of said top layer and said lower layer is metal.

21. The cooking system according to claim 9 wherein:
at least two of said top layer, said middle layer, and said lower layer are held together by chemical bonding or cladding.

22. The cooking system according to claim 9 wherein:
at least two layers of said top layer, said middle layer, and said lower layer are held together by nesting said at least two layers.

23. The cooking system according to claim 9 wherein:
said top layer and said lower layer are non-ferritic and said lower layer is nested in a ferritic base.

24. The cooking system according to claim 9 wherein:
the cooking system is an outdoor grill.

25. The cooking system according to claim 9 wherein:
wherein cooking system is an indoor grill.
